(19) United States
(12) Patent Application Publication
(10) Pub. No.: US 2024/0136750 A1
(43) Pub. Date: Apr. 25, 2024

(54) CONNECTOR

(71) Applicant: Kitagawa Industries Co., Ltd., Inazawa-shi, Aichi (JP)

(72) Inventor: Yuya OKADA, Kasugai-shi, Aichi (JP)

(21) Appl. No.: 18/277,689

(22) PCT Filed: Mar. 7, 2022
(86) PCT No.: PCT/JP2022/009703

§ 371 Date: Aug. 16, 2023

(30) Foreign Application Priority Data
Mar. 25, 2021 (JP) 2021-053677

(51) Int. Cl. H01R 13/193; H01R 13/03; H01R 13/11; H01R 13/7193

(52) U.S. Cl. CPC H01R 13/193; H01R 13/113; H01R 13/7193; H01R 13/03

(57) ABSTRACT

A connector including: a conductive portion that is brought into pressure contact with a bus bar and is electrically connected to the bus bar when the bus bar is inserted into an inserted portion; and a pressing portion configured to be displaceable to a first position and a second position, and receives a force acting from the bus bar when the bus bar is inserted into the inserted portion, is displaced from the first position to the second position, and presses the conductive portion at the time of the displacement to elastically deform at least a part of the conductive portion, in which the conductive portion is configured to cause, when pressed by the pressing portion and elastically deformed, an elastic force generated with the elastic deformation to act on the bus bar to increase a contact pressure with respect to the bus bar.

### CROSS-REFERENCE TO RELATED APPLICATION

The present international application claims priority based on Japanese Patent Application No. 2021-053677 filed with the Japanese Patent Office on Mar. 26, 2021, and the entire content of Japanese Patent Application No. 2021-053677 is incorporated herein by reference.

### TECHNICAL FIELD

The present disclosure relates to a connector.

### BACKGROUND ART

For example, a connector for a flat conductor described in Patent Document 1 below is known. The connector described in Patent Document 1 below includes a terminal and a pressing member. When the pressing member is rotated, the pressing member lifts a front end of an upper arm portion of the terminal upward. At this time, the upper arm portion swings with the position of a coupling portion as a fulcrum, and a rear end of the upper arm is displaced downward. Due to this, a pressing portion provided at the rear end of the upper arm portion is displaced downward, a flat conductor is pressed against a contact portion, and the contact pressure is increased.

### CITATION LIST

### Patent Literature

Patent Document 1: Japanese Unexamined Patent Application Publication No. 2018-37190A

### SUMMARY OF INVENTION

### Technical Problem

However, in the case of the connector described in Patent Document 1 described above, in order to increase the contact pressure between the flat conductor and the terminal, at least two or more operations of inserting the flat conductor into the connector and rotating the pressing member are required. Therefore, there is a demand for further simplifying these operations. In a case where two operations as described above are required, if the operator forgets to perform the operation of rotating the pressing member, the contact pressure between the flat conductor and the terminal becomes insufficient. This causes a problem that the conductive performance is deteriorated or the conductive performance becomes instable.

In one aspect of the present disclosure, it is desirable to provide a connector that can simplify a connection operation of a bus bar and appropriately ensure a contact pressure between the bus bar and a terminal.

### Solution to Problem

A connector in one aspect of the present disclosure includes at least one inserted portion, at least one conductive portion, and at least one pressing portion. The inserted portion is configured to be insertable with a bus bar. When the bus bar is inserted into the inserted portion, the conductive portion is brought into pressure contact with the bus bar and is electrically connected to the bus bar. The pressing portion is configured to be displaceable to a first position and a second position, receives a force acting from the bus bar when the bus bar is inserted into the inserted portion, is displaced from the first position to the second position, and presses the conductive portion at the time of the displacement to elastically deform at least a part of the conductive portion. The conductive portion is configured to cause, when the conductive portion being pressed by the pressing portion and elastically deformed, an elastic force generated with the elastic deformation to act on the bus bar to increase a contact pressure with respect to the bus bar.

According to the connector configured as described above, when the bus bar is inserted into the inserted portion, the pressing portion receives a force acting from the bus bar and is displaced from the first position to the second position. At that time, the pressing portion presses the conductive portion to elastically deform at least a part of the conductive portion. When pressed by the pressing portion and elastically deformed, the conductive portion causes an elastic force generated by the elastic deformation to act on the bus bar to increase a contact pressure with respect to the bus bar. Therefore, it is possible to suppress the bus bar from being displaced in a direction of coming out of the inserted portion as compared with a case of not including an equivalent of the pressing portion as described above.

Moreover, when the bus bar is inserted into the inserted portion, the pressing portion receives a force acting from the bus bar and is displaced from the first position to the second position. Therefore, other than the operation of inserting the bus bar into the inserted portion, the operation of displacing the pressing portion from the first position to the second position needs not be performed. Therefore, it is possible to simplify the operation process as compared with the case where it is necessary to perform the operation of inserting the bus bar into the inserted portion and the operation of displacing the pressing portion from the first position to the second position. The operator does not forget to perform the operation of displacing the pressing portion. Therefore, the contact pressure between the conductive portion and the bus bar will not be insufficient due to such an operation error. Therefore, according to such connector, it is possible to appropriately ensure the contact pressure between the conductive portion and the bus bar, and it is possible to suppress the conductive performance from deteriorating and becoming instable.

The connector in one aspect of the present disclosure may further include the following configuration.

The conductive portion may include a contact portion, a lever portion, and a support portion. The contact portion is brought into contact with the bus bar. The lever portion is pressed by the pressing portion when the pressing portion is displaced from the first position to the second position. The support portion supports the contact portion and the pressing portion. When the lever portion is pressed by the pressing portion upon the displacement of the pressing portion from the first position to the second position, the lever portion and the contact portion swing relative to the support portion while at least a part of the conductive portion is elastically deformed, and the contact pressure between the contact portion and the bus bar increases.

According to the connector configured as described above, the conductive portion includes the contact portion, the lever portion, and the support portion as described above. When the lever portion is pressed by the pressing portion, the lever portion and the contact portion swing relative to the support portion while at least a part of the conductive portion is elastically deformed, and the contact pressure between the contact portion and the bus bar increases. Therefore, according to such connector, it is possible to suppress the bus bar from being displaced in a direction of coining out of the inserted portion as compared with a case of not including an equivalent of the pressing portion as described above.

In the connector in one aspect of the present disclosure, the conductive portion may include a first metal member configured to be brought into pressure contact with a first surface, and a second metal member configured to be brought into pressure contact with a second surface, of the first surface and the second surface on both sides in a plate thickness direction of the bus bar.

According to the connector configured as described above, since the conductive portion includes the first metal member and the second metal member as described above, the conductive portion is brought into pressure contact with both the first surface and the second surface of the bus bar. Therefore, the conductive portion can hold the bus bar from the both sides in the plate thickness direction, and can enhance the effect of suppressing the bus bar from being displaced in a direction of coming out of the inserted portion.

The connector in one aspect of the present disclosure may include a first inserted portion and a second inserted portion as the at least one inserted portion. In the connector, the conductive portion provided in the first inserted portion and the conductive portion provided in the second inserted portion may be electrically connected.

According to the connector configured as described above, it is possible to electrically connect the two bus bars by inserting the bus bar into each of the first inserted portion and the second inserted portion.

The connector in one aspect of the present disclosure may include a magnetic core including a magnetic material. The connector may be configured such that a conductive path formed by at least one of the conductive portion and the bus bar inserted into the inserted portion is disposed at a position penetrating the inner peripheral side of the magnetic core.

According to the connector configured as described above, since the magnetic core as described above is included, it is possible to suppress a noise current from flowing through the conductive path.

### BRIEF DESCRIPTION OF DRAWINGS

FIG. 1A is a perspective view of a connector as viewed from an upper right front. FIG. 1B is a perspective view of the connector as viewed from a lower left rear.

FIG. 2A is a perspective view illustrating an internal structure with a part of the connector being broken. FIG. 2B is an enlarged perspective view of a pressing component and a conductive component.

FIG. 3A is a cross-sectional view illustrating the pressing component and the conductive component in a state where the bus bar is not inserted into the inserted portion. FIG. 3B is a cross-sectional view illustrating the pressing component and the conductive component in a state where the bus bar is inserted into the inserted portion.

FIG. 4A is a plan view of the connector. FIG. 4B is a front view of the connector: FIG. 4C is a right side view of the connector.

### REFERENCE SIGNS LIST

1 Connector, 3 Inserted portion, 5 Conductive portion, 7 Pressing portion, 9 Magnetic core, 11 Connection mechanism, 13 Resin member, 15A First metal member, 15B Second metal member, 17 Base portion, 20 Case, 21 First case component, 22 Second case component, 31 Contact portion, 33 Lever portion, 35 Support portion, 41 Bus bar.

### DESCRIPTION OF EMBODIMENTS

Next, the above-described connector will be described with reference to an exemplary embodiment.

### [Configuration of Connector]

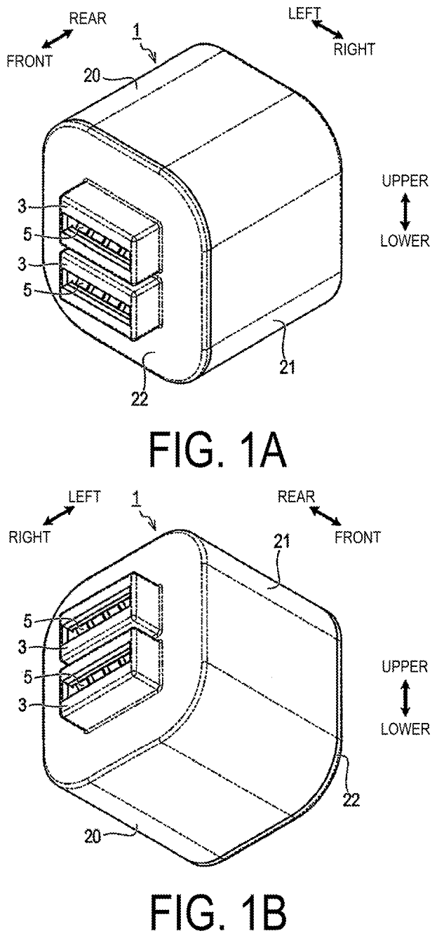

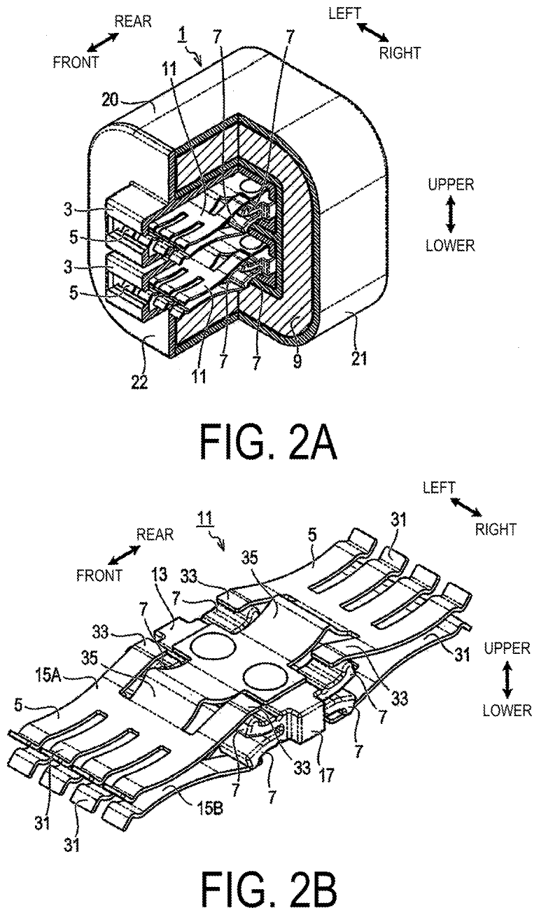

As illustrated in FIGS. 1A, 1B, 2A, and 2B, a connector 1 includes an inserted portion 3, a conductive portion 5, a pressing portion 7, and a magnetic core 9. In the case of the present embodiment, the connector 1 includes two connection mechanisms 11 as illustrated in FIG. 2A. As illustrated in an enlarged view of FIG. 2B, this connection mechanism 11 includes a resin member 13 made of resin, and a first metal member 15A and a second metal member 15B made of thin plate-shaped metal (e.g., copper alloy). The resin member 13 includes the pressing portion 7 described above and a base portion 17. The pressing portion 7 and the base portion 17 are integrally molded with a resin material. The first metal member 15A and the second metal member 15B constitute the conductive portion 5 described above.

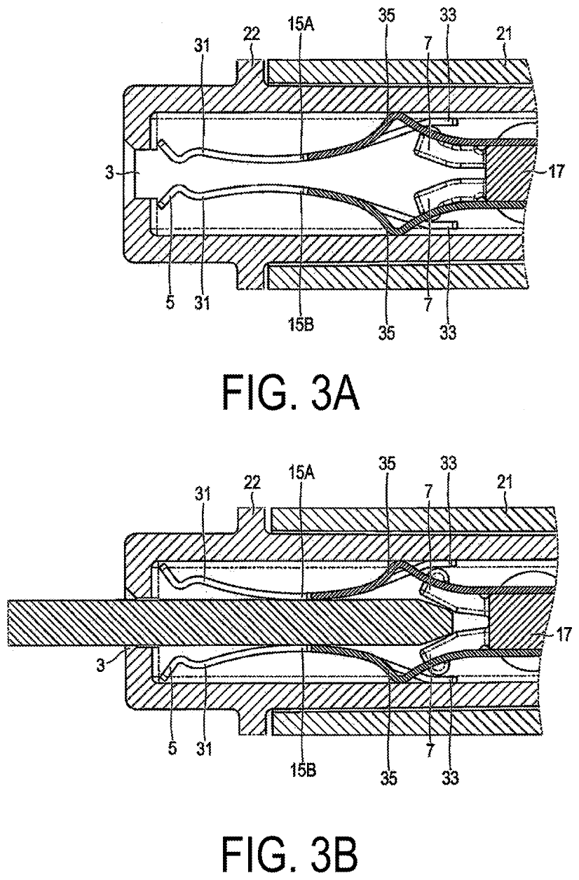

In the case of the present embodiment, the connector 1 includes a case 20 made of resin. Two inserted portions 3 described above are provided at each of the front end and the rear end of the case 20. These four inserted portions 3 are configured to be insertable with a bus bar 41 (see FIG. 3B) into each of the inserted portions 3. The case 20 includes a first case component 21 and a second case component 22. The front end of the case 20 is configured by the second case component 22. The rear end of the case 20 is configured by the first case component 21.

The first metal member 15A and the second metal member 15B constitute one conductive portion 5 on the front end side, and constitute one conductive portion 5 on the rear end side. That is, the first metal member 15A and the second metal member 15B constitute two conductive portions 5. In other words, one connection mechanism 11 includes two conductive portions 5. In the connector 1, two connection mechanisms 11 are arranged at intervals in the up-down direction (see FIG. 2A). Therefore, the connector 1 includes four conductive portions 5.

One conductive portion 5 configured on the front end side of the first metal member 15A and the second metal member 15B and one conductive portion 5 configured on the rear end side of the first metal member 15A and the second metal member 15B are always in a state of being electrically connected to each other due to their structures. Therefore, among the four conductive portions 5 included in the connector 1, the two conductive portions 5 arranged on the upper side are always in an electrically connected state, and the two conductive portions 5 arranged on the lower side are always in an electrically connected state.

The four conductive portions 5 are each located at a position corresponding to the inserted portion 3. When the bus bar 41 is inserted into the inserted portion 3, each of the conductive portions 5 is electrically connected to the bus bar 41. At this time, in each of the conductive portions 5, the first metal member 15A is brought into pressure contact with the first surface and the second metal member 15B is brought into pressure contact with the second surface, of the first surface and the second surface on the both sides in the plate thickness direction of the bus bar 41. This brings the bus bar 41 into a state of being held between the first metal member 15A and the second metal member 15B. That is, the bus bar 41 is held between the first metal member 15A and the second metal member 15B.

In the case of the present embodiment, each of the conductive portions 5 includes a contact portion 31, a lever portion 33, and a support portion 35. The contact portion 31 is a portion that is brought into contact with the bus bar 41 when the bus bar 41 is inserted into the inserted portion 3. Although described in detail later, the lever portion 33 is a portion pressed by the pressing portion 7. The support portion 35 is a portion that supports the contact portion 31 and the lever portion 33. The first metal member 15A and the second metal member 15B are fixed to the above-described base portion 17 in the vicinity of the center in the front-rear direction. Therefore, in each of the conductive portions 5, one end of the support portion 35 is fixed to the base portion 17, and the contact portion 31 and the lever portion 33 are supported by the support portion 35.

In the case of the present embodiment, the first metal member 15A and the second metal member 15B are components having the same shape when any one of them is reversed by 180 degrees to turn upside down. Therefore, each of the first metal member 15A and the second metal member 15B includes portions corresponding to the contact portion 31, the lever portion 33, and the support portion 35. As described above, the first metal member 15A and the second metal member 15B are components constituting the conductive portion 5 on the front end side and the rear end side of each of them. Therefore, each of the front end side and the rear end side of the first metal member 15A includes portions corresponding to the contact portion 31, the lever portion 33, and the support portion 35. Each of the front end side and the rear end side of the second metal member 15B includes portions corresponding to the contact portion 31, the lever portion 33, and the support portion 35.

The pressing portion 7 extends from the base portion 17. As illustrated in FIGS. 3A and 3B, a tip side in an extending direction of the pressing portion 7 is in contact with the lever portion 33 described above. As illustrated in FIG. 3A, in a state where the bus bar 41 is not inserted into the inserted portion 3, the pressing portion 7 is at the first position. When the bus bar 41 is inserted into the inserted portion 3, the pressing portion 7 is elastically deformed by receiving the force applied from the bus bar 41, and is displaced from the first position illustrated in FIG. 3A to the second position illustrated in FIG. 3B.

At this time, in FIG. 3B, the pressing portion 7 on the upper side of the bus bar 41 swings clockwise to press the lever portion 33. The lever portion 33 is pressed upward by the pressing portion 7 and swings anticlockwise about in the vicinity of a connection part with the support portion 35. At this time, a part of the conductive portion 5 is elastically deformed in the vicinity of the connection part between the support portion 35 and the lever portion 33, and the contact portion 31 is biased anticlockwise by the elastic force. As a result, the contact pressure between the contact portion 31 and the bus bar 41 increases.

In FIG. 3B, the pressing portion 7 on the lower side of the bus bar 41 swings anticlockwise to press the lever portion 33. The lever portion 33 is pressed downward by the pressing portion 7 and swings clockwise about in the vicinity of the connection part with the support portion 35. At this time, a part of the conductive portion 5 is elastically deformed in the vicinity of the connection part between the support portion 35 and the lever portion 33, and the contact portion 31 is biased clockwise by the elastic force. As a result, the contact pressure between the contact portion 31 and the bus bar 41 increases.

That is, when the bus bar 41 is interposed between the two pressing portions 7 above and below the bus bar 41, the two pressing portions 7 swing in a direction where the interval between the pressing portions 7 increases. The two lever portions 33 above and below the two pressing portions 7 are pressed by the pressing portion 7, and swing in a direction where the interval between the lever portions 33 increases. As a result, the two contact portions 31 are biased in the same direction as the swing direction of the lever portion 33 corresponding to each contact portion, and the contact pressure with respect to each bus bar 41 increases. That is, a holding force increases in the first metal member 15A and the second metal member 15B in a state of holding the bus bar 41.

The magnetic core 9 is configured with a magnetic material. In the case of the present embodiment, the magnetic core 9 is configured of a sintered body of ferrite. The first case component 21 has a tubular cavity whose front end is an opening surface, and the magnetic core 9 is contained in this cavity. The second case component 22 functions as a lid that closes the opening surface at the front end of the first case component 21. When the bus bar 41 is inserted into the inserted portion 3, the conductive path formed by the conductive portion 5 and the bus bar 41 is disposed at a position penetrating the inner peripheral side of the magnetic core 9. Therefore, by providing such the magnetic core 9, it is possible to suppress a noise current from flowing through the conductive path.

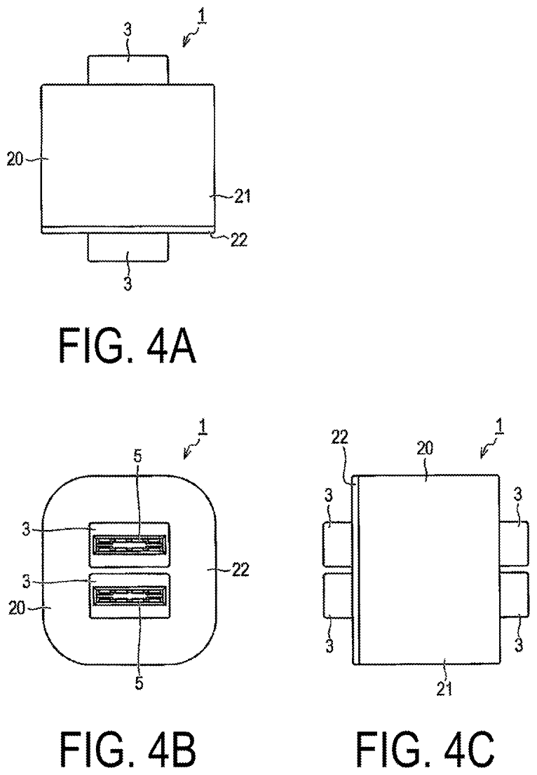

FIG. 4A is a plan view of the connector 1. A bottom view of the connector 1 appears symmetrically with the plan view. FIG. 4B is a front view of the connector 1. A rear view of the connector 1 appears same as the front view. FIG. 4C is a right side view of the connector 1. A left side view of the connector 1 appears symmetrically with the right side view.

### Beneficial Effects

According to the connector 1 configured as described above, it is possible to suppress the bus bar 41 from being displaced in a direction of coming out of the inserted portion 3 as compared with a case of not including a structure equivalent to the pressing portion 7 as described above. Moreover, when the bus bar 41 is inserted into the inserted portion 3, the pressing portion 7 receives a force acting from the bus bar 41 and is displaced from the first position to the second position. Therefore, other than the operation of inserting the bus bar 41 into the inserted portion 3, the operation of displacing the pressing portion 7 from the first position to the second position needs not be performed.

Therefore, according to the connector 1, it is possible to simplify the operation process as compared with the case where it is necessary to perform the operation of inserting the bus bar 41 into the inserted portion 3 and the operation of displacing the pressing portion 7 from the first position to the second position. The operator does not forget to perform the operation of displacing the pressing portion 7. Therefore, the contact pressure between the conductive portion 5 and the bus bar 41 will not be insufficient due to such an operation error. Therefore, it is possible to appropriately ensure the contact pressure between the conductive portion 5 and the bus bar 41, and it is possible to suppress the conductive performance from deteriorating and becoming instable.

In the case of the present embodiment, the conductive portion 5 can hold the bus bar 41 from the both sides in the plate thickness direction. Therefore, according to the connector 1, as compared with the case where the conductive portion 5 is configured to be brought into pressure contact with only one surface of the bus bar 41, it is possible to enhance the effect of suppressing the bus bar 41 from being displaced in a direction of coining out of the inserted portion 3.

In the case of the present embodiment, the inserted portion 3 on the front end side of the connector 1 (corresponding to the first inserted portion in the present disclosure) and the inserted portion 3 on the rear end side of the connector 1 (corresponding to the second inserted portion in the present disclosure) are electrically connected. Therefore, according to the connector 1, by inserting the bus bar 41 into each of the two inserted portions 3 described above, it is possible to electrically connect the two bus bars 41.

### OTHER EMBODIMENTS

Although the connector of the present disclosure has been described above with reference to the exemplary embodiment, the above-described embodiment is merely an example presented as one aspect of the present disclosure. That is, the present disclosure is not limited to the exemplary embodiments described above, and can be carried out in various forms without departing from the technical concept of the present disclosure.

For example, in the above embodiment, the conductive portion 5 includes the contact portion 31, the lever portion 33, and the support portion 35, but it is not essential to include all of the contact portion 31, the lever portion 33, and the support portion 35 as long as equivalent functions can be achieved.

In the above embodiment, the conductive portion 5 is configured to be brought into pressure contact with both the first surface and the second surface of the bus bar 41, but may be configured to be brought into pressure contact with either one of the surfaces. Also in this case, by providing the pressing portion 7 as described above, it is possible to increase the contact pressure of the conductive portion 5 with respect to the bus bar 41.

In the above embodiment, the two conductive portions 5 are electrically connected, and when the bus bar 41 is inserted into each of the two inserted portions 3, the two bus bars 41 are electrically connected. However, it is discretionary whether or not to adopt such configuration. For example, a configuration in which one conductive portion 5 and a conductive path different from the conductive portion 5 in the present disclosure (e.g., simple electric wire or the like) are electrically connected may be adopted. In this case, by inserting the bus bar 41 into one inserted portion 3, it is possible to electrically connect the bus bar 41 and the conductive path different from the conductive portion 5 in the present disclosure (e.g., simple electric wire or the like).

In the above embodiment, the connector 1 includes the magnetic core 9, but it is discretionary whether or not to include the magnetic core 9.

In the above embodiment, an example in which the magnetic core 9 is configured with a sintered body of ferrite has been described, but a magnetic core formed of another material may be used. Examples other than ferrite include amorphous alloys and nanocrystalline alloys. The nanocrystalline alloy is an alloy in which an amorphous alloy is subjected to a heat treatment in a magnetic field to nanocrystalize a part of the amorphous alloy. In a case where the magnetic core is configured with an amorphous alloy or a nanocrystalline alloy, it is only required to form a belt-shaped body with the amorphous alloy or the nanocrystalline alloy, for example, and wind the belt-shaped body to form an annular body that can be used as a magnetic core.

Note that a plurality of functions implemented by one component illustrated in the above embodiment may be implemented by a plurality of components. One function implemented by one component illustrated in the above embodiment may be implemented by a plurality of components. A plurality of functions implemented by a plurality of components illustrated in the above embodiment may be implemented by one component. One function implemented by a plurality of components illustrated in the above embodiment may be implemented by one component. Additionally, a portion of the configurations exemplified in the embodiments described above may be omitted.

1. A connector comprising:
at least one inserted portion each configured to be insertable with a bus bar;
at least one conductive portion that is each brought into pressure contact with the bus bar and is electrically connected to the bus bar when the bus bar is inserted into a corresponding one inserted portion of the at least one inserted portion; and
at least one pressing portion each configured to be displaceable to a first position and a second position, the at least one pressing portion each configured to receive a force acting from the bus bar when the bus bar is inserted into a corresponding one inserted portion of the at least one inserted portion, to be displaced from the first position to the second position, and to press a corresponding one conductive portion of the at least one conductive portion at a time of the displacement to elastically deform at least a part of the corresponding one conductive portion, wherein
the at least one conductive portion is each configured to cause, when a conductive portion of the at least one conductive portion being pressed by a corresponding one pressing portion of the at least one pressing portion and elastically deformed, an elastic force generated with the elastic deformation to act on the bus bar to increase a contact pressure with respect to the bus bar.

2. The connector according to claim 1, wherein
the at least one conductive portion each includes
a contact portion that is brought into contact with the bus bar,
a lever portion that is pressed by a corresponding one pressing portion of the at least one pressing portion when the corresponding one pressing portion is displaced from the first position to the second position, and
a support portion that supports the contact portion and the corresponding one pressing portion, and
when the lever portion is pressed by the corresponding one pressing portion upon the displacement of the corresponding one pressing portion from the first position to the second position, the lever portion and the contact portion swing relative to the support portion while at least a part of a corresponding one conductive portion of the at least one conductive portion is elastically deformed, and the contact pressure between the contact portion and the bus bar increases.

3. The connector according to claim 1, wherein
the at least one conductive portion each further includes
a first metal member configured to be brought into pressure contact with the first surface, and
a second metal member configured to be brought into pressure contact with a second surface, of the first surface and the second surface on both sides in a plate thickness direction of the bus bar.

4. The connector according to claim 1 comprising
a first inserted portion and a second inserted portion as the at least one inserted portion, wherein
a conductive portion of the at least one conductive portion provided in the first inserted portion and a conductive portion of the at least one conductive portion provided in the second inserted portion are electrically connected.

5. The connector according to claim 1 further comprising
a magnetic core including a magnetic material, wherein
a conductive path formed by at least one of a conductive portion of the at least one conductive portion and the bus bar inserted into a corresponding one inserted portion of the at least one inserted portion is configured to be disposed at a position penetrating an inner peripheral side of the magnetic core.
